(19) United States
(12) Patent Application Publication
(10) Pub. No.: US 2008/0246843 A1
(43) Pub. Date: Oct. 9, 2008

(54) Periphery monitoring system for vehicle

(75) Inventors: Asako Nagata, Chita-city (JP); Tsuneo Uchida, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/078,451

(22) Filed: Mar. 31, 2008

(30) Foreign Application Priority Data
Apr. 3, 2007 (JP) 2007-97471

(51) Int. Cl. H04N 7/18

(52) U.S. Cl. 348/148

(57) ABSTRACT

A periphery monitoring system for a vehicle captures an image of a mobile object in a first field of view. The system captures an image of the mobile object in a second field of view that is located on a downstream side of the first field of view in an approaching direction of the vehicle. The first display region of the system displays the captured image along a first trajectory. When the mobile object enters into the second field of view after crossing the first field of view, the image of the mobile object is displayed along a second trajectory in the second display region of the system successively from the first display region. The system causes an auxiliary image to be displayed in the second display region in accordance with the entering of the mobile object into the second field of view.

### CROSS REFERENCE TO RELATED APPLICATION

This application is based on and incorporates herein by reference Japanese Patent Application No. 2007-97471 filed on Apr. 3, 2007.

### BACKGROUND OF THE INVENTION

1. Field of the Invention

The present invention relates to a vehicle periphery monitoring system.

2. Description of Related Art

JP Patent No. 3511892 corresponding to U.S. Pat. No. 6,476,855 describes a monitoring system that includes three cameras that capture images at a position directly rearward of the vehicle, at a rear left position, and a rear right position such that the images captured by the cameras are monitored. As shown in FIG. 12A to 12D, the captured images 71, 73, 72 captured by the three cameras are trimmed such that the images 71, 73, 72 are defined by a mask region 74 that has a shape associated with rear side windows of the vehicle. Thereby, the above image arrangement may facilitate the intuitive understanding of the image.

However, in the monitoring system of JP Patent No. 3511892 corresponding to U.S. Pat. No. 6,476,855, only the shape of the mask region is sufficiently associated with the rear side compartment of the vehicle. Thus, the projected images, specifically the rear left and rear right images 71, 72 appear widely differently from actual visual images of the rear windows. As a result, the user may disadvantageously feel something wrong. In other words, as shown in FIG. 2, the three cameras 201, 401, 101 mounted on the rear side of the vehicle basically have separated view fields X, Y, Z, or separated fields X, Y, Z of view from each other. Thus, the separated fields X, Y, Z of view are not continuous in a movement direction of a vehicle T that crosses through a space at the rear side of the vehicle. Thus, when the vehicle T travels across the above three image view fields X, Y, Z, the images of the vehicle T are not captured at the separated parts of the view field. As a result, the discontinued image is displayed piece by piece at the three display regions 71, 73, 72 that correspond to the view fields X, Y, Z. In the above case, if the images of the vehicle T in the three display regions 71, 73, 72 are continued in the movement direction, the discontinuity or the break of the images may not be noticeable. Also, if the images of the vehicle T in the three display regions 71, 73, 72 are continued in the movement direction, the image that moves through the three display regions may be easily recognized as the same vehicle T.

However, in fact, the rear lateral side display regions 71, 72 are arranged to be positioned above the direct rear display region 73 and are adjacent to each other horizontally as shown in FIGS. 12A to 12D. Also, the cameras 201, 101 that capture images at the rear right side and rear left side are angled relative to the camera 401 that captures images at the direct rear side, and thereby the angles for capturing image are different from each other. Typically, the cameras 201, 101 are angled to capture images of a target from an oblique-forward side or an oblique-rearward side relative to the target, and the camera 401 is angled to capture images of the target from a direct-lateral side of the target, such as the vehicle T. As a result, the following failure may occur. For example, when the vehicle T approaches from the rear left side of the vehicle, the captured images of the vehicle T are shown in the order of FIG. 12A, FIG. 12B, and FIG. 12C. Specifically, the captured images of the vehicle T gradually becomes larger and moves rightward in the rear left image display region 71 at the upper left portion of the display device 70. Then, as shown in FIG. 12D, the enlarged image of the vehicle T suddenly appears in the direct rear display region 73 from a left side of the region. Accordingly, the above enhances the user to feel the discontinuity and the separation in the image display. As a result, when the image of the vehicle T moves from the rear left image display region 71 to the direct rear display region 73, the user may falsely feel that the vehicle T disappears for a moment and this greatly bewilders the user. Also, the above false feeling may disadvantageously limit the user from quickly recognizing that both the image a vehicle displayed in the rear left image display region 71 and the image of a vehicle displayed in the direct rear display region 73 correspond to the same vehicle T. The above separation feeling of the image may be enhanced when the mask region is located between the display region 71 and the display region 73.

### SUMMARY OF THE INVENTION

The present invention is made in view of the above disadvantages. Thus, it is an objective of the present invention to address at least one of the above disadvantages.

According to one aspect of the present invention, there is provided a periphery monitoring system for a vehicle, which system includes first capturing means, second capturing means, mobile object image display means, and auxiliary image display means. The first capturing means captures an image of a mobile object in a first field of view. The mobile object approaches the vehicle. The first field of view is located on an upstream side of the vehicle in an approaching direction, in which the mobile object approaches the vehicle. The first capturing means is mounted on the vehicle. The second capturing means captures an image of the mobile object in a second field of view, which field includes an immediately close region of the vehicle. The second field of view is located on a downstream side of the first field of view in the approaching direction. The mobile object image display means has a first display region and a second display region arranged adjacently to each other. The first display region displays the image captured by the first capturing means. The image is moved along a first trajectory in the first display region. The second display region displays the image captured by the second capturing means. When the mobile object enters into the second field of view after crossing the first field of view, the image of the mobile object is displayed along a second trajectory in the second display region successively from the image in the first display region. The auxiliary image display means causes an auxiliary image to be displayed in the second display region in accordance with the entering of the mobile object into the second field of view from the first field of view. The auxiliary image is displayed for getting attention to the mobile object that approaches the immediately close region of the vehicle.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram illustrating an example of an electric configuration of a vehicle periphery monitoring system of one embodiment of the present invention;

FIG. 2 is a plan schematic view illustrating an example of an arrangement of in-vehicle cameras and illustrating view fields;

FIG. 3 is a schematic diagram illustrating an arrangement of radars;

FIG. 4 is a diagram illustrating an example of a display screen;

FIG. 5 is a diagram for explaining a method for determining a trajectory and an image display position of an auxiliary image;

FIG. 6A is a diagram illustrating one state in a monitoring process achieved by the one embodiment of the present invention;

FIG. 6B is another diagram illustrating another state in the process continued from FIG. 6A:

FIG. 6C is still another diagram illustrating still another state in the process continued from FIG. 6B;

FIG. 7A is still another diagram illustrating still another state in the process continued from FIG. 6C;

FIG. 7B is still another diagram illustrating still another state in the process continued from FIG. 7A;

FIG. 7C is still another diagram illustrating still another state in the process continued from FIG. 7B;

FIG. 7D is still another diagram illustrating still another state in the process continued from FIG. 7C;

FIG. 8A is still another diagram illustrating still another state in the process continued from FIG. 7D;

FIG. 8B is still another diagram illustrating still another state in the process continued from FIG. 8A;

FIG. 8C is still another diagram illustrating still another state in the process continued from FIG. 8B;

FIG. 9 is a diagram illustrating one display state for displaying the auxiliary image according to a first modification;

FIG. 10 is a diagram illustrating another display state for displaying the auxiliary image according to a second modification;

FIG. 11A is a diagram illustrating still another display state for displaying the auxiliary image according to a third modification;

FIG. 11B is a diagram illustrating still another display state for displaying the auxiliary image according to the third modification;

FIG. 12A is a diagram illustrating one state in a monitoring process for explaining a disadvantage of a conventional vehicle periphery monitoring system;

FIG. 12B is a diagram illustrating another state in the monitoring process continued from FIG. 12A;

FIG. 12C is a diagram illustrating still another state in the monitoring process continued from FIG. 12B; and

FIG. 12D is a diagram illustrating still another state in the monitoring process continued from FIG. 12B.

### DETAILED DESCRIPTION OF PREFERRED EMBODIMENTS

One embodiment of the present invention will be described referring to accompanying drawings.

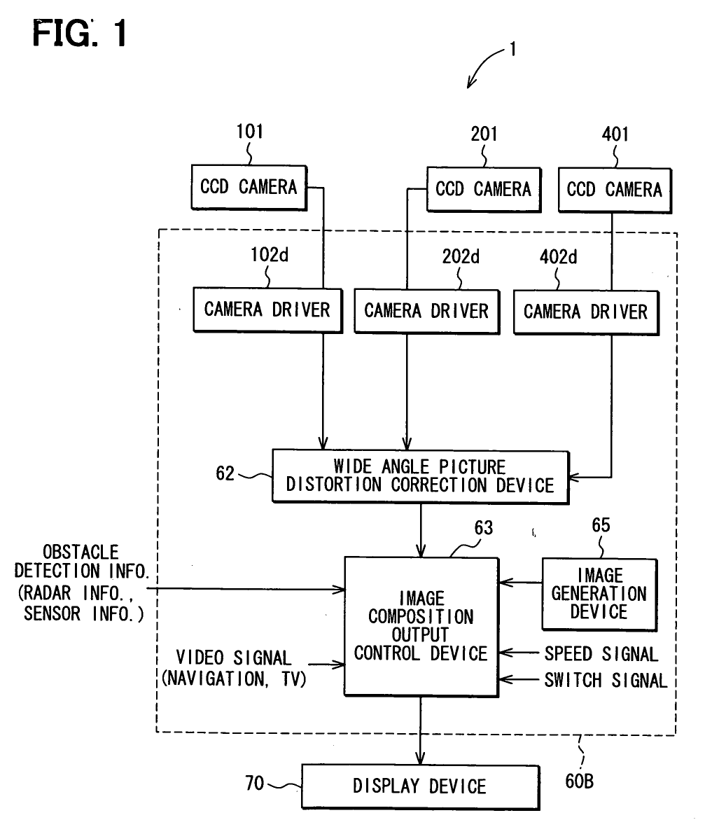

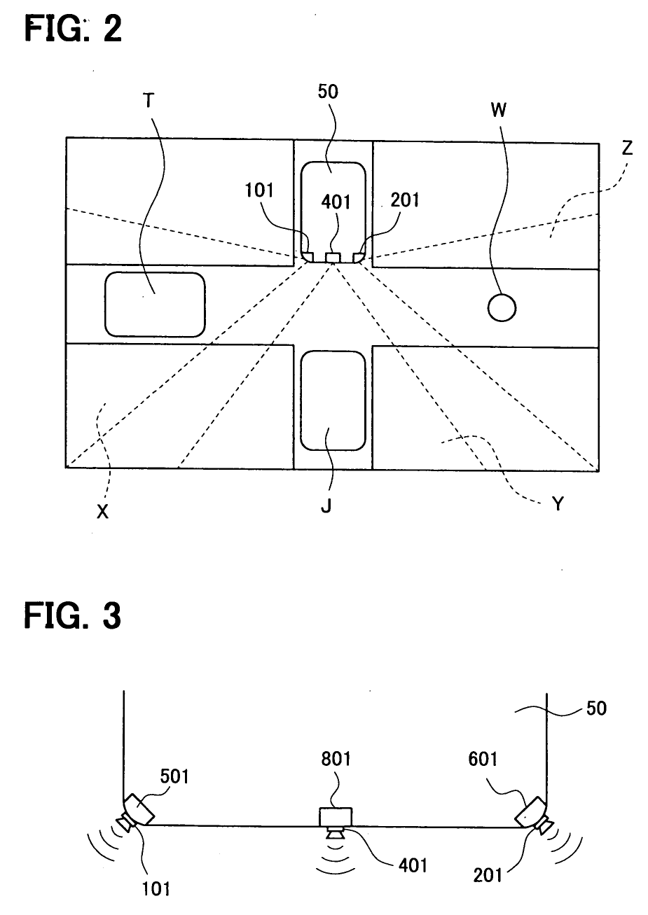

FIG. 1 a block diagram illustrating an example of an electric configuration of a vehicle periphery monitoring system 1 according to the present embodiment of the present invention. The vehicle periphery monitoring system 1 monitors a rear side of a vehicle, on which the monitoring system 1 is mounted. The vehicle periphery monitoring system 1 includes charge coupled device (CCD) cameras 101, 201, which capture images of the rear left side and rear right side of the vehicle, and a CCD camera 401, which captures an image in the third direction that is directly directed rearward of the vehicle. As shown in FIG. 2, The CCD cameras 101, 201 are mounted on both ends of the rear bumper, and the CCD camera 401 is provided at a central portion of the rear bumper. As a result, the system is able to capture the images in the field of view having an horizontal angle of more than 180°. The CCD camera 101 serves as rear left capturing means for capturing the image in a rear left view field X, which is one of rear lateral side view fields of the vehicle 50. Also, the CCD camera 102 serves as rear right capturing means for capturing image in a rear right view field Z positioned at a rear right side of the vehicle 50. The CCD camera 401 serves as direct rear capturing means for capturing image at the direct rear view field positioned at a directly rearward of the vehicle 50.

The CCD cameras 101, 201, 401 output video signals through a control unit 60B to a display device 70 (mobile object image display means) that is provided at a rear portion in a vehicle compartment. Here, the display device 70 faces toward a front side of the vehicle 50. the display device 70 includes a liquid crystal display and is enabled to display a picture of a various contents other than the above, such as navigation information, and TV programs. A control unit 60 includes camera drivers 102d, 202d, 402d, a wide angle picture distortion correction device 62, an image composition output control device 63, and an image generation device 65.

Each of the CCD cameras 101, 201, 401 is connected with the wide angle picture distortion correction device 62 via a corresponding one of the camera drivers 102d, 202d, 402d. The wide angle picture distortion correction device 62 corrects distortion of the picture distorted due to the wide angle lens mounted on each camera and outputs the corrected video signal indicative of the corrected picture to the image composition output control device 63. The image composition output control device 63 is connected with the image generation device 65. The image generation device 65 includes a dedicated graphic IC and generates trimmed pictures, vehicle images (mobile object images), emphasis images, and auxiliary images. The image composition output control device 63 includes a microcomputer hardware.

Next, as shown in FIG. 3, in a rear portion of the vehicle 50, radars 501, 601, 801 are attached at a position corresponding to each of the CCD cameras 101, 201, 401 for detecting an obstacle existing in a capturing direction, in which each camera captures the images. For example, the obstacle may be the other vehicle T or a pedestrian W in FIG. 2. Each of the above radars 501, 601, 801 is used to measure a speed of a mobile object T that crosses the view field of the corresponding camera and to measure a distance to the mobile object T from the vehicle 50. Also, each radar 501, 601, 801 measures a position in the view field. The above radars 501, 601, 801 serve as main part of travel speed determining means, mobile object image position determining means, and mobile object distance detection means. As shown in FIG. 1, the detection information by the radars 501, 601, 801 is inputted to the image composition output control device 63.

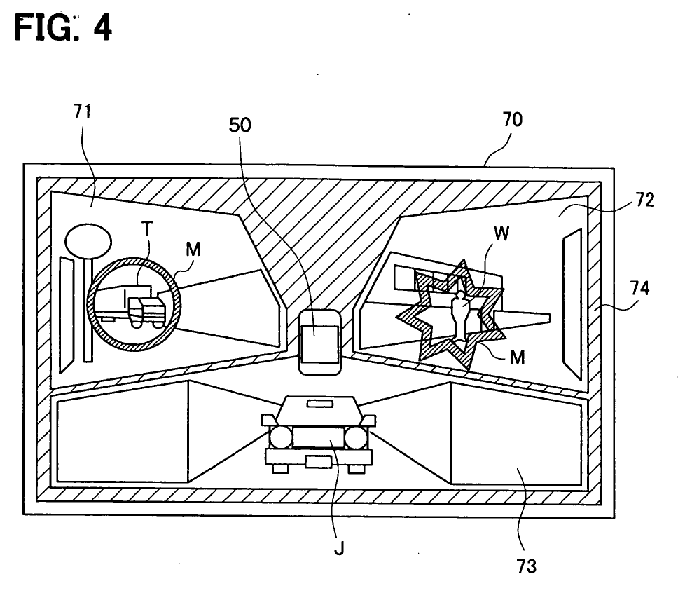

The image composition output control device 63 executes mounted programs to composite a single image having a layout shown in FIG. 4 from the captured images captured by the three CCD cameras 101, 201, 401 and generates monitor image data by superimposing the trimmed pictures, the emphasis images, and the auxiliary images generated by the image generation device 65 onto one another. The image composition output control device 63 outputs the video signal to the display device 70 based on the above data. The position and the speed of the other vehicle or the mobile object captured by the above three CCD cameras 101, 201, 401 are computed based on the detection information by the above radars 501, 601, 801, and the image position and the speed of the other vehicle are determined or specified based on the computation result of each captured image. Composition positions or superimposing positions of the emphasis image and the auxiliary image on the captured images are determined based on the information of the determined image position and the determined speed of the other vehicle. In other words, the image composition output control device 63 constitutes emphasis image display means and auxiliary image display means.

Also, the image composition output control device 63 is enabled to receive other video signals from a vehicle navigation system and a TV and receives the control signals, such as a vehicle speed signal, a switch signal. The switch signal is generated by an operated switch when the display screen is switched. For example, the switch signal is inputted to the image composition output control device 63 for a control, in which the navigation information is exclusively displayed when the vehicle speed exceeds a predetermined value. The display device 70 displays a navigation picture and a TV picture and also displays a monitored image upon selection.

In FIG. 2, one of the three CCD cameras serves as first capturing means for capturing an image in a first field of view X that is directed to an upstream side of the vehicle 50 in an approaching direction, in which the other vehicle T (mobile object) approaches the vehicle 50. Another one of the three CCD cameras serves as second capturing means for capturing an image of the mobile object in a second field of view Y, which corresponds to an downstream side of the first field of view X in the approaching direction, and which includes an immediate close region of the vehicle 50. Here, the immediate close region is located sufficiently close to the rear side of the vehicle 50. In FIG. 2, the other vehicle T is a target to be captured that approaches the lateral side of the vehicle 50. One of the cameras that captures an image of the approaching other vehicle T in the view field X serves as the first capturing means. The CCD camera 401 is used as the second capturing means that captures the image of the other vehicle T located at the rear side of the vehicle 50. In the above case, if the other vehicle T approaches the vehicle 50 from the rear left side of the vehicle 50, the CCD camera 101 that captures an image of the rear left view field X serves as the first capturing means. Also, if the other vehicle T approaches the vehicle 50 from the rear right side of the vehicle 50, the CCD camera 201 that captures the image of the rear right view field Z serves as the first capturing means. FIG. 2 shows a case, where the other vehicle T approaches the vehicle 50 from the rear left side of the vehicle 50.

Also, as shown in FIG. 4, the display device 70 is configured to have a rear left image display region 71, a rear right image display region 72, and a direct rear image display region 73 in the same liquid crystal display. The direct rear image display region 73 displays the image of the direct rear view field Y. The rear left image display region 71 displays an image of the rear left view field X at an upper side of the direct rear image display region 73. The rear right image display region 72 displays an image of the rear right view field Z. One of the rear left image display region 71 and the rear right image display region 72 that is located at an approaching side of the vehicle 50 is used as the first display region. In the above description, the other vehicle T approaches the vehicle 50 from the approaching side of the vehicle 50. The direct rear image display region 73 is used as the second display region. The present embodiment is described by an example, in which the other vehicle T approaches the vehicle 50 from the rear left side of the vehicle 50.

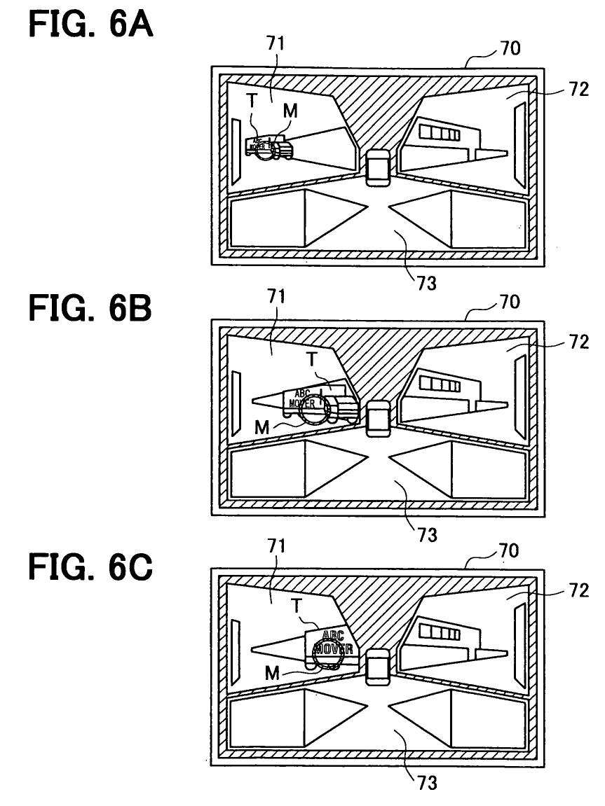

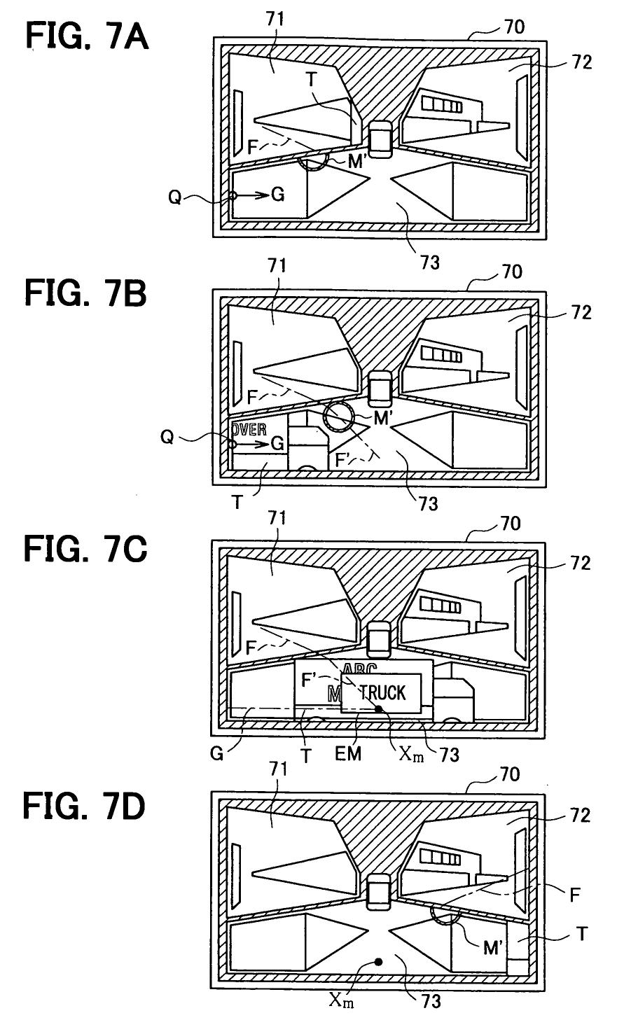

As shown in FIG. 2, when the other vehicle T is entering the direct rear view field Y after the other vehicle T has crossed the rear left view field X, the image of the other vehicle T moves from the rear left image display region 71 to the direct rear image display region 73, as shown in FIGS. 6A to 6C and FIGS. 7A to 7D. Specifically, the image of the other vehicle T is displayed at an image developing position Q in the rear left image display region 71 and is moved along a trajectory G. In this way, the image of the other vehicle T is moved successively or transitions from the rear left image display region 71 to the direct rear image display region 73. In the above description, the image developing position Q in the rear left image display region 71 is located at a position away from an imaginary extension of the trajectory F. In other words, as shown in FIGS. 6A to 6C and FIG. 7A, the image of the other vehicle T is firstly displayed at a left side in the rear left image display region 71 and is displayed gradually larger as the image moves rightward in the region 71. Then, as shown in FIGS. 7B to 7D, the enlarged image of the other vehicle T appears in the direct rear image display region 73 from a left side of the region 73. However, as shown in FIGS. 7A and 7B, when the other vehicle T moves from the rear left view field X to the direct rear view field Y, the auxiliary image M′ is displayed along another trajectory F′ in the direct rear image display region 73 correspondingly to the movement of the other vehicle T in the view fields. Here, the other trajectory F′ in the direct rear image display region 73 is connected with the trajectory F in the rear left image display region 71.

If the image of the other vehicle T moves in the rear left image display region 71 as shown in FIGS. 6A, 6B, 6C, 7A, the user is supposed to expect that the image of the other vehicle T moves in the direct rear image display region 73 also in a direction that is estimated based on or is associated with the movement direction of the image in the image display region 71. However, in fact, the image of the other vehicle T does not move in the above expected direction when in the direct rear image display region 73, and thereby, the above unexpected movement direction may provide the discontinuity and the separation for the display of the image of the other vehicle T. Thus, the auxiliary image M′ is made appear in the direct rear image display region 73 and is caused to move along the other trajectory F′ such that the separation of the image is mitigated and the eyes or attention of the user is smoothly directed to the direct rear image display region 73. As a result, the user is kept paying attention to the other vehicle T that travels to the direct rear position of the vehicle 50. In the above, the other trajectory F′ corresponds to the direction, which the user is supposed to expect for the image of the vehicle T to move, and is connected with the trajectory F in the rear left image display region 71. In FIG. 2, the other vehicle T that travels to cross the rear left view field X and the direct rear view field Y has a travel speed that is determined by the radars 501, 801 shown in FIG. 3. In FIGS. 6A to 6C and FIGS. 7A to 7D, the auxiliary image M′ is displayed to move along the auxiliary image guidance trajectory F′ at the speed that corresponds to the acquired travel speed. The auxiliary image guidance trajectory F′ is the other trajectory F′ that is connected with the trajectory F shown in the rear left image display region 71.

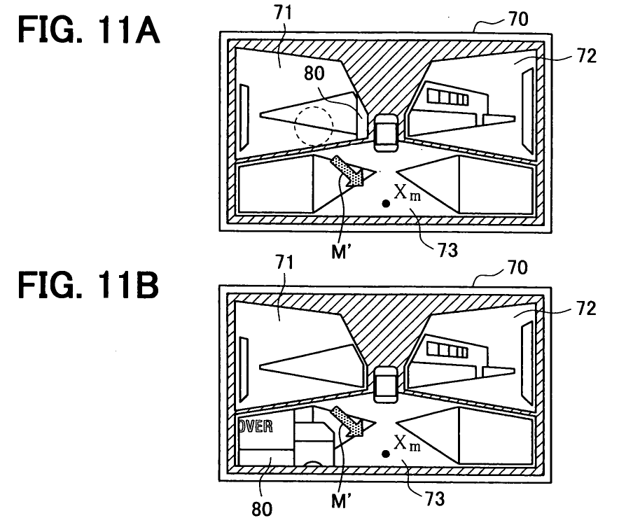

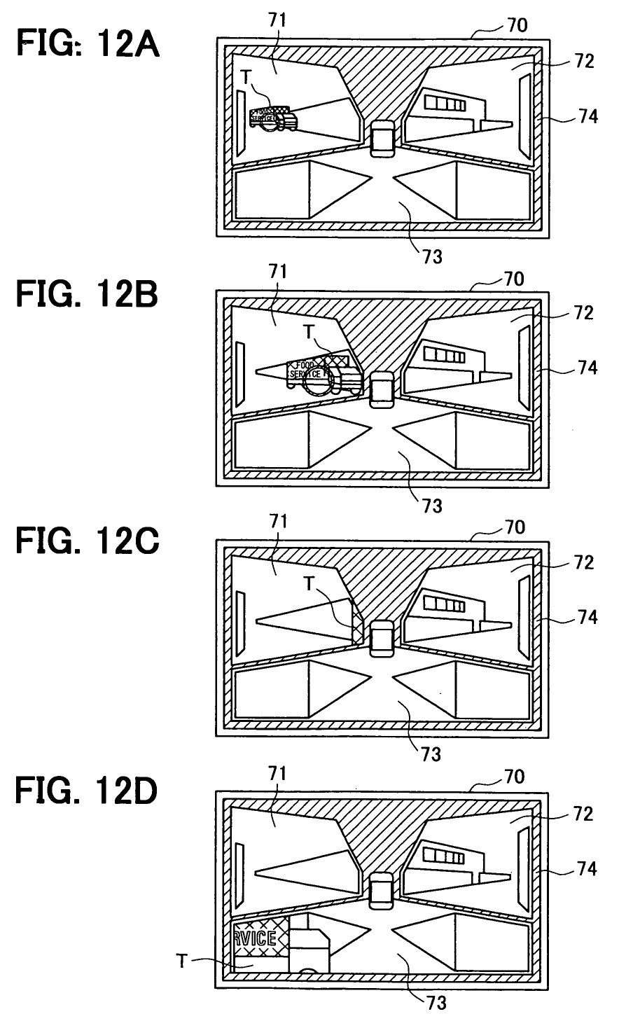

Also, the position of the other vehicle T that moves in the rear left view field X shown in FIG. 2 is detected by the radar 501 shown in FIG. 3. Then, the position of the image of the other vehicle T in the rear left image display region 71 is determined or specified based on the position information. As shown in FIG. 4, an emphasis image M is displayed at the specified position of the image of the other vehicle T such that the position of the other vehicle T is emphasized. As shown in FIGS. 7B, 7C, the auxiliary image M′ is caused to be moved in the image display region 73 along the auxiliary image guidance trajectory F′ such that the movement of the auxiliary image M′ is successive to the movement of the emphasis image M that moves in the rear left image display region 71. Note that, as shown in FIGS. 11A, 11B, the auxiliary image M′ that stays at a position along the auxiliary image guidance trajectory F′ may be alternatively displayed. In FIGS. 11A, 11B, the auxiliary image M′ indicates a direction toward a reference point Xm along the auxiliary image guidance trajectory F′ and has a figure shape marked with an arrow that indicates the direction.

Note that, even when another mobile object, such as a pedestrian W, exists in the view field, a similar emphasis image M is displayed. For example, in FIG. 4, the similar emphasis image M is displayed around the pedestrian W in the rear right image display region 72. In the present embodiment, it is determined whether the mobile object is the vehicle or the pedestrian based on an outline shape and a travel speed of the image of the mobile object, and different emphasis images that are different from each other in shapes are displayed for indicating the vehicle and the pedestrian. The distance between the other vehicle T and the vehicle 50 is detected by the radar 501, and the size of the emphasis figure image M displayed in the display device 70 is made larger as the distance becomes shorter (see FIG. 6A to 6C).

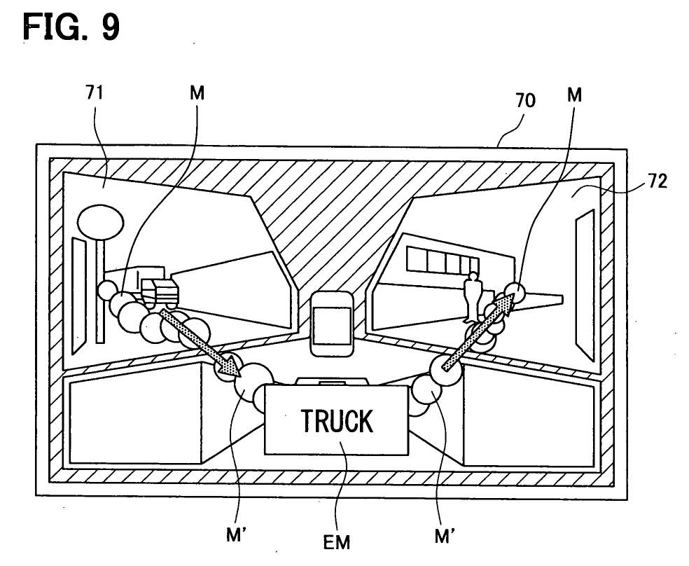

The emphasis image M is an emphasis figure image that is superimposed on the image of the other vehicle T and is a circular figure image having a ring shape part of an alert color and of a certain width. For example, the circular figure image has a red or yellow color. The emphasis image M has a line shaped image outline portion that is opaque and is superimposed on the image of the other vehicle T to cover the image of the other vehicle T. A center portion of the emphasis image M inside the image outline portion is clear such that the other vehicle T behind the emphasis image M is visible as shown in FIG. 9 in the present embodiment. However, the center portion may be painted such that the center portion becomes opaque. Note that, for example, the emphasis image M may be a frame that surrounds the image of the other vehicle T. Also, the emphasis image M may be a marking of the alert color, and the marking may be to the image of the other vehicle T using an alpha blend.

Also, as shown in FIG. 7B, the auxiliary image M′ is an auxiliary figure image that has the same shape with the shape of the emphasis figure image M. For example, the auxiliary image M′ has the circular shape. The distance to the other vehicle T that is within the direct rear view field Y is detected by the radar 801, and the auxiliary figure image M′ is more enlarged when the distance becomes smaller.

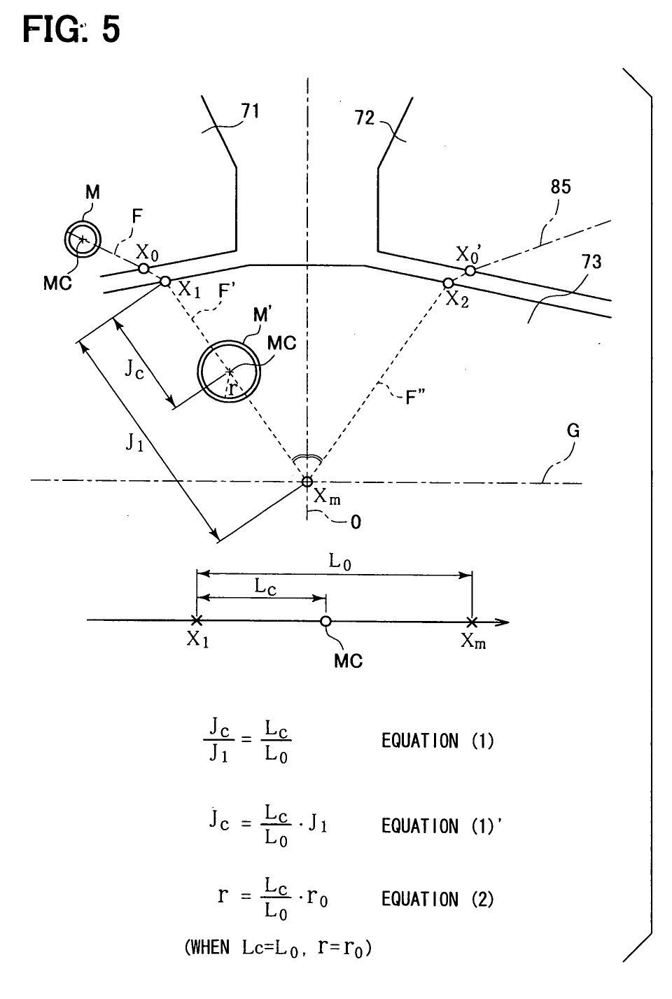

As shown in FIG. 5, the auxiliary image guidance trajectory F′ in the direct rear image display region 73 is directed in a direction different from the direction of the trajectory F of the image of the other vehicle T in the image display region 71. In the present embodiment, the reference point Xm is defined at a central position between a left edge and a right edge of the direct rear image display region 73 on a reference line G that indicates a trajectory G of the other vehicle T in the direct rear image display region 73. In the above definition, the direct rear image display region 73 is formed symmetrically relative to the central position, and the central position indicates a direct rear position, at which the other vehicle T is positioned most closely to the vehicle 50. The trajectory F of the image of the other vehicle T in the rear left image display region 71 has an end point X0 in the region 71. Also, the trajectory F is extended toward the direct rear image display region 73 to have an intersection point X1 at an edge of the region 73. The auxiliary image guidance trajectory F′ is defined as an straight line that connects the intersection point X1 and the reference point Xm.

The auxiliary image M′ is moved and displayed along the auxiliary image guidance trajectory F′ to synchronize with the position of the other vehicle T or the travel speed of the other vehicle T detected by the radar 801. The mount position and angle of each of the CCD cameras 101, 401, 201 is fixed such that an actual distance L0 on the road at the rear of the vehicle between the start point (intersection point) X1 of the auxiliary image guidance trajectory F′ and the reference point Xm is known. Thus, a distance Lc from a start position on the road to a present position of the other vehicle T on the road is acquired based on the position of the other vehicle T detected by the radar 801. In the above definition, the start position is a position on the road that corresponds to the start point X1. Then, MC indicates a display position, at which the auxiliary image M′ is displayed, on the auxiliary image guidance trajectory F′ that extends from the point X1 to the point Xm in the display screen. In the above case, the following equation is satisfied.

Jc/J1=Lc/L0 Equation (1)

wherein, J1 is a distance between the point X1 and the point Xm in the display, and Jc is a distance between the point X1 and the display position MC in the display. Thus, the distance Jc indicating a distance to the display position MC of the auxiliary image M′ is computed as follows.

Jc=(Lc/L0)×J1 Equation (1)′

Also, a display scale for displaying the auxiliary image M′ is indicated as a radius r, and for example, when Lc is L0, the radius r is defined as r0. Also, the radius r is defined to change in proportion to the distance Lc. The radius r for any distance Lc under the above condition is computed in the following equation.

r=(Lc/L0)×r0 Equation (2)

When the other vehicle T enters into the direct rear view field Y, the actual image of the other vehicle T moves along the trajectory G that extends in a horizontal direction in the direct rear image display region 73 as shown in FIG. 7B. Before long, the actual image reaches the reference point Xm as shown in FIG. 7C. As above, the reference point Xm indicates the intersection position or the closest approach position. In the present embodiment, an auxiliary image EM is superimposed onto the image of the other vehicle T at the reference point Xm such that at least a part of the image of the other vehicle T is covered. The auxiliary image EM has a rectangular shape and is opaque, for example. The rectangular shape of the auxiliary image EM is larger than the circular image. Note that the radius r of the circular image becomes r0 in a case where Lc=L0 as shown in the above equation (2). As a result, the coverage of the actual image of the other vehicle T by the auxiliary image EM is increased. Also, a type of the other vehicle T is specified based on the outline shape of the actual image of the other vehicle T, and the type name is displayed or superimposed on the auxiliary image EM. In the present embodiment, the type of the other vehicle T is a truck.

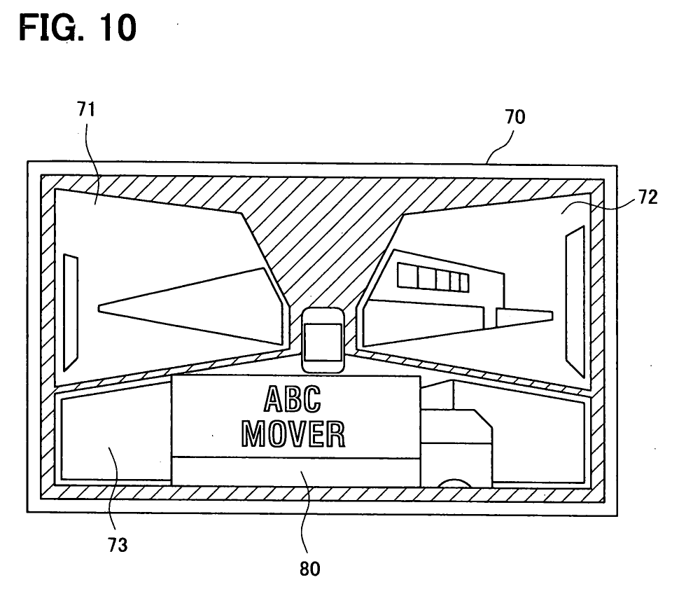

Note that, as shown in FIG. 10, at a time when the image of the other vehicle T reaches the reference point Xm, the auxiliary image M′ may be made invisible. In other words, the auxiliary image M′ may be displayed only before the auxiliary image M′ reaches the reference point Xm and after the auxiliary image M′ leaves the reference point Xm.

Next, in FIG. 4, one of the rear left image display region 71 and the rear right image display region 72 serves as a third display region that displays the other vehicle T, which travels away from the vehicle 50. In the above case, the one of the regions 71, 72 corresponds to a view located on a side of the vehicle 50, from which side the other vehicle T travels away from the vehicle 50. Thus, the one of the regions 71, 72 is the rear right image display region 72 in the above case. As shown in FIG. 7D, the auxiliary image M′ is displayed in an area between the reference point Xm and a trajectory 85 of the other vehicle T displayed in the rear right image display region 72 (third display region). As shown in FIG. 5, in the above case, the auxiliary image M′ is moved and displayed along the auxiliary image guidance trajectory F″ that is set from the reference point (intersection position) Xm toward the trajectory 85 shown in the rear right image display region 72. In the present embodiment, the auxiliary image guidance trajectory F″ is a straight line that is symmetrical to the auxiliary image guidance trajectory F′ relative to a center line O. As above, the auxiliary image guidance trajectory F′ is located on an approaching side of the center line O, from which side the other vehicle T approaches the vehicle 50. As shown in FIG. 5, the center line O passes through the reference point Xm and is orthogonal to the trajectory G displayed in the direct rear image display region 73.

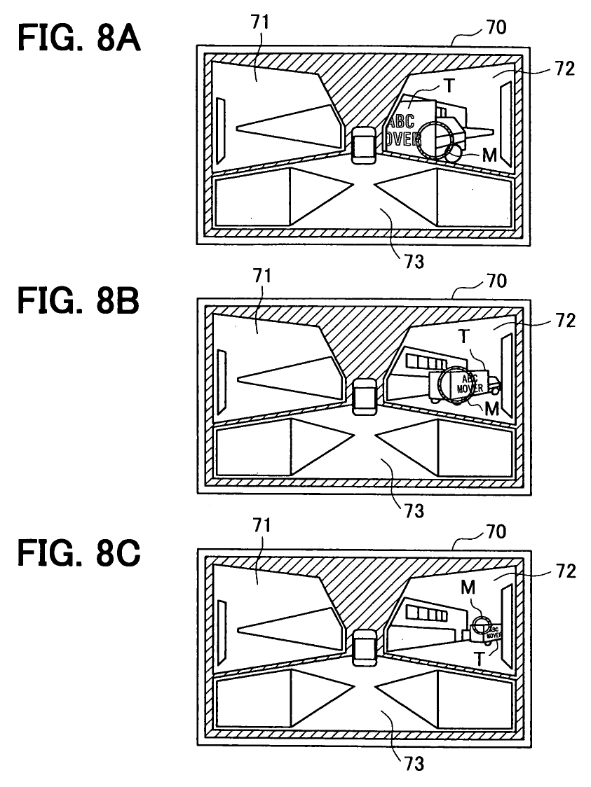

As shown in FIGS. 8A to 8C, the actual image of the other vehicle T is displayed in the rear right image display region 72 (third display region). In other words, the actual image of the other vehicle T is successively moved from the direct rear image display region 73 to the rear right image display region 72. Then, the emphasis image M is displayed at a specified position of the image of the other vehicle T based on the position or the speed of the other vehicle T specified by the radar 201. Thus, it is possible to certainly understand or know a process, in which the mobile object approaches the rear side of the vehicle and then the mobile object passes the rear side of the vehicle. Also, it is possible to effectively understand the going away of the mobile object, to which the attention has been paid.

In the above embodiment, the auxiliary image is displayed. As a result, even when the captured images of multiple view fields, which are different from each other in an angle for capturing a subject, are combined, it is possible to have intuitive understanding of the existence and the movement of the subject.

In the above embodiment, the emphasis image display means is provided. As a result, the emphasis image is used for notifying the user of the existence of the mobile object that needs to be paid attention for safety, such as the other vehicle approaching the rear of the vehicle. Thereby, it is possible to provide an alert to the user at an earlier time for paying attention.

In the above embodiment, the emphasis image may be, for example, a marking image having a predetermined shape, such as a circle or polygon, and it is still possible to sufficiently achieve the above advantages for getting the attraction of the user. Also, the emphasis image is simply generated in addition to the mobile object image for overlapping or superimposing, it is possible to simplify the picture processing procedure. The emphasis image may be made into an emphasis figure image that is superimposed on the image of the mobile object to cover the image of the mobile object such that the integrity between (a) the mobile object image and (b) the emphasis image is enhanced. Thus, the emphasis image may guide the user to understand the mobile object position. As a result, it is possible to smoothly get the attention of the user even for the auxiliary image located at a position that is different from a position of the mobile object image in the second display region.

In the above embodiment, in a case, where the emphasis figure image is used to cover the part of the mobile object image, by enlarging the emphasis figure image in accordance with a size of the mobile object image, it is possible to sufficiently keep the coverage ability to cover the mobile object image regardless of the distance to the mobile object.

In the above embodiment, the auxiliary image may be made into the auxiliary figure image that has an identical shape with the shape of the emphasis figure image. As a result, even in the second display region, where the corresponding relation between (a) the mobile object image and (b) the emphasis figure image may be lost, it is still possible to cause the user to immediately understand that the auxiliary figure image corresponds to or is successive to the emphasis figure image of the mobile object.

The auxiliary image guidance trajectory has a direction that is different from a direction of the trajectory of the mobile object image in the second display region. Accordingly, the auxiliary image guidance trajectory and the trajectory of the mobile object image in the second display region intersect with each other at a point somewhere. In a case, where the auxiliary image is moved along the auxiliary image guidance trajectory in synchronism with the travel speed of the mobile object, the auxiliary image on the auxiliary image guidance trajectory corresponds to an actual position of the mobile object image only at the intersection position. The intersection position also indicates a position, at which the mobile object approaches the vehicle closest.

There may be two cases for a display state, where the mobile object image reaches the intersection position, or the closest approach position. In one case, the auxiliary image display means causes the auxiliary image to be superimposed onto the image of the mobile object at the intersection position between the auxiliary image guidance trajectory F′ and the trajectory G of the mobile object in the second display region such that the image of the mobile object is partially covered. As above, the user continuously understands the mobile object position due to the emphasis image M or the auxiliary image M′ even when the mobile object image is in the first display region. As a result, the mobile object image is covered by the same auxiliary image M′ even at the closest approach position. Thereby, it is possible to accurately detect the arrival or approach of the mobile object to the closest approach position.

In contrast, in another case, where the user sufficiently identifies the mobile object based on the image in the first display region, the user may understand the present position of the mobile object in the first display region by tracing the position of the actual image of the mobile object. For example, when the emphasis image M is not displayed in the first display region or when the coverage of the mobile object by the emphasis image M is small, the user may understand the present position of the mobile object in the first display region. In the above case, the auxiliary image display means causes the auxiliary image M′ to be invisible or not to be displayed at a time when the image of the mobile object reaches the intersection position Xm between the auxiliary image guidance trajectory F′ and the trajectory G in the second display region. In other words, the actual image of the mobile object may be sufficiently advantageously used for providing an alert to the user only at the closest approach position.

Because the direct rear view field of the vehicle is displayed along with the rear lateral side view field of the vehicle, it is easily visually recognize the surrounding of the rear side of the vehicle, which surrounding is otherwise difficult to see. As a result, the user is able to accurately understand the other vehicle that crosses the rear side of the vehicle. Specifically, in a case, where the vehicle is moved backward from a parking area that faces a road, the user is able to more effectively recognize the other vehicle. Also, in another case, where the other vehicle T travels from a narrow road having blind spots into a road, on which the vehicle 50 travels, the user on the vehicle 50 is also able to more effectively recognize the other vehicle T.

In the above embodiment, the mobile object may approach the vehicle from a rear right side or a rear left side of the vehicle. In order to deal with the above, the vehicle is provided with the rear left capturing means for capturing the image in the rear left view field of the vehicle and the rear right capturing means for capturing the image in the rear right view field of the vehicle.

In the above embodiment, the direct rear image display region, the rear left image display region, and the rear right image display region are defined by the image mask region in the same screen of the display device. Also, each of the image display regions is defined to have a shape that is associated with a corresponding window of the vehicle. As a result, the display device shows the image similar to an image that can be observed when the user looks backward at the driver seat toward the rear side of the passenger compartment of the vehicle. Thus, it is made possible to more easily understand or see the physical relation and the perspective of the mobile object in the image captured in the direct rear side, the rear left side, or the rear right side of the vehicle. The trimming of the images or the defining of the images by the mask region may increase the separation of the actual images of the mobile object between the adjacent display regions. However, in the above embodiment, the auxiliary image is displayed to effectively moderate the influence due to the trimming.

In the above embodiments, the trajectory F of the image of the other vehicle T in the rear left image display region 71 corresponds to the first trajectory, along which the image of the mobile object is displayed in the first display region, for example. Also, the trajectory G of the image of the other vehicle T in the direct rear image display region 73 corresponds to the second trajectory, along which the image of the mobile object is moved in the second display region, for example. Further, the auxiliary image guidance trajectory F′ of the auxiliary image in the direct rear image display region 73 corresponds to the third trajectory, along which the auxiliary image is displayed in the second display region, for example. Further still, the trajectory 85 of the image of the other vehicle in the rear right image display region 72 corresponds to the fourth trajectory of the mobile object in the third display region, for example. Further, the trajectory F″ of the auxiliary image in the direct rear image display region 73 corresponds to the fifth trajectory, along which the auxiliary image is displayed in the second display region, for example.

What is claimed is:

1. A periphery monitoring system for a vehicle comprising:
first capturing means for capturing an image of a mobile object in a first field of view, the mobile object approaching the vehicle, the first field of view being located on an upstream side of the vehicle in an approaching direction, in which the mobile object approaches the vehicle, the first capturing means being mounted on the vehicle;
second capturing means for capturing an image of the mobile object in a second field of view, which field includes an immediately close region of the vehicle, the second field of view being located on a downstream side of the first field of view in the approaching direction;
mobile object image display means for having a first display region and a second display region arranged adjacently to each other, wherein:
the first display region displays the image captured by the first capturing means, the image being moved along a first trajectory in the first display region;
the second display region displays the image captured by the second capturing means; and
when the mobile object enters into the second field of view after crossing the first field of view, the image of the mobile object is displayed along a second trajectory in the second display region successively from the image in the first display region; and
auxiliary image display means for causing an auxiliary image to be displayed in the second display region in accordance with the entering of the mobile object into the second field of view from the first field of view, the auxiliary image being displayed for getting attention to the mobile object that approaches the immediately close region of the vehicle.

2. The periphery monitoring system according to claim 1, further comprising:
travel speed determining means for determining a travel speed of the mobile object that crosses the first field of view and the second field of view, wherein:
the auxiliary image display means causes the auxiliary image to be moved along a third trajectory at a speed that corresponds to the determined travel speed, the third trajectory being connected with the first trajectory.

3. The periphery monitoring system according to claim 2, further comprising:
mobile object image position determining means for determining a position of the image of the mobile object in the first display region; and
emphasis image display means for causing an emphasis image to be displayed at the determined position of the image of the mobile object and to be moved together with the image of the mobile object, the emphasis image being displayed to emphasize the position of the image of the mobile object, wherein:
the auxiliary image display means causes the auxiliary image to be displayed and moved along the third trajectory such that the auxiliary image display means causes the auxiliary image to be displayed and moved successively from the emphasis image in the first display region.

4. The periphery monitoring system according to claim 3, wherein the emphasis image is an emphasis figure image that is superimposed on the image of the mobile object.

5. The periphery monitoring system according to claim 4, wherein the emphasis image is the emphasis figure image that is superimposed on the image of the mobile object to cover the image of the mobile object.

6. The periphery monitoring system according to claim 4, further comprising:
mobile object distance detection means for detecting a distance from the mobile object to the vehicle, wherein:
the emphasis image display means causes the emphasis figure image to be displayed larger when the distance becomes smaller.

7. The periphery monitoring system according to claim 4, wherein the auxiliary image display means causes the auxiliary image to be displayed as an auxiliary figure image that has an identical shape with the emphasis figure image.

8. The periphery monitoring system according to claim 7, further comprising:
mobile object distance detection means for detecting a distance from the mobile object to the vehicle, wherein:
the auxiliary image display means causes the auxiliary figure image to be displayed larger when the distance becomes smaller.

9. The periphery monitoring system according to claim 2, wherein:
the auxiliary image display means causes the auxiliary image to be superimposed on the image of the mobile object at an intersection position such that the auxiliary image covers at least a part of the image of the mobile object, the intersection position being located between the second trajectory and the third trajectory.

10. The periphery monitoring system according to claim 2, wherein:
the auxiliary image display means causes the auxiliary image to be invisible at a time when the image of the mobile object reaches an intersection position between the second trajectory and the third trajectory.

11. The periphery monitoring system according to claim 1, wherein:
the first capturing means captures the image in a view field of a rear lateral side of the vehicle as the first field of view; and
the second capturing means captures the image in a view field of a direct rear side of the vehicle as the second field of view.

12. The periphery monitoring system according to claim 11, further comprising:
rear left capturing means for capturing an image in a rear left view field located at a rear left side of the vehicle; and
rear right capturing means for capturing an image in a rear right view field located at a rear right side of the vehicle, wherein:
one of the rear left capturing means and the rear right capturing means serves as the first capturing means, the one of the rear left capturing means and the rear right capturing means being located on an approaching side of the vehicle, from which side the mobile object approaches the vehicle; and
the mobile object image display means includes a direct rear image display region, a rear left image display region, and a rear right image display region, the rear left image display region and the rear right image display region being arranged adjacently to each other on a side of the direct rear image display region, the direct rear image display region displaying the image in the direct rear view field, the rear left image display region displaying the image in the rear left view field, the rear right image display region displaying the image of the rear right view field, one of the rear left image display region and the rear right image display region serving as the first display region, the one of the display regions corresponds to the approaching side of the vehicle, the direct rear image display region serving as the second display region.

13. The periphery monitoring system according to claim 12, wherein:
each of the direct rear image display region, the rear left image display region, and the rear right image display region is defined by an image mask region in a common screen of the mobile object image display means such that the each of the regions is associated with a shape of a corresponding window of the vehicle.

14. The periphery monitoring system according to claim 12, wherein:
an other one of the rear left image display region and the rear right image display region serves as a third display region, the other one of the regions being located on an away side of the vehicle, from which side the mobile object moves away from the vehicle, the auxiliary image display means causing the auxiliary image to be displayed at a position located between the intersection position and a fourth trajectory of the mobile object in the third display region.

15. The periphery monitoring system according to claim 14, wherein:
the auxiliary image display means causes the auxiliary image to be displayed and moved along a fifth trajectory that is set from the intersection position to the fourth trajectory.

16. The periphery monitoring system according to claim 14, further comprising:
mobile object image position determining means for determining a position of the image of the mobile object in the third display region; and
emphasis image display means for causing an emphasis image to be displayed at the determined position of the image of the mobile object together with the mobile object image, the emphasis image being used for emphasizing the mobile object position.

17. The periphery monitoring system according to claim 1, wherein the auxiliary image display means causes the auxiliary image to be displayed along a third trajectory that is connected with the first trajectory.

18. The periphery monitoring system according to claim 1, wherein the image of the mobile object is displayed and moved from an image start position in the second display region when the mobile object enters into the second field of view after crossing the first field of view, the image start position being located out of an imaginary extension of the first trajectory.

19. The periphery monitoring system according to claim 1, wherein:
the first capturing means is mounted to the vehicle on an upstream side of the vehicle in the approaching direction; and
the mobile object image display means has the first display region that is located on a side in a display screen of the mobile object image display means, correspondingly to the upstream side of the vehicle.

20. The periphery monitoring system according to claim 19, further comprising:
third capturing means for capturing an image of the mobile object in a third field of view, the third field of view being located on a downstream side of the second field of view in the approaching direction, wherein:
the mobile object image display means further includes a third display region that displays the image captured by the third capturing means; and
the third display region and the first display region are arranged adjacent to each other on a side of the second display region.

21. The periphery monitoring system according to claim 20, wherein:
the first capturing means captures the image in one of a rear right side and a rear left side of the vehicle; and
the third capturing means captures the image in the other one of the rear right side and the rear left side of the vehicle.

22. The periphery monitoring system according to claim 19, wherein:
the mobile object image position determining means determines a position of the image of the mobile object in the third display region; and
the emphasis image display means causes the emphasis image to be displayed at the determined position of the image of the mobile object and to be moved together with the image of the mobile object in the third display region.

23. A periphery monitoring system for a vehicle comprising:
first capturing means for capturing an image of a mobile object in a first field of view, the mobile object approaching the vehicle, the first field of view being located on an upstream side of the vehicle in an approaching direction, in which the mobile object approaches the vehicle, the first capturing means being mounted on the vehicle;
second capturing means for capturing an image of the mobile object in a second field of view, which field includes an immediately close region of the vehicle, the second field of view being located on a downstream side of the first field of view in the approaching direction;
mobile object image display means for having a first display region and a second display region arranged adjacently to each other, the first display region displaying the image captured by the first capturing means, the second display region displaying the image captured by the second capturing means; and
auxiliary image display means for causing an auxiliary image to be displayed in the second display region when the mobile object is displayed from the first display region to the second display region, the auxiliary image indicating a direction, in which the mobile object is displayed.
